(19) United States
(12) Patent Application Publication
(10) Pub. No.: US 2018/0326802 A1
(43) Pub. Date: Nov. 15, 2018

(54) REDUCING WEAR IN HITCH APPARATUSES

(71) Applicant: POWER PIN INC., Fort Qu'Appelle, Saskatchewan (CA)

(72) Inventor: Brian R. OLSON, Fort Qu'Appelle, Saskatchewan (CA)

(73) Assignee: POWER PIN INC., Fort Qu'Appelle, Saskatchewan (CA)

(21) Appl. No.: 15/525,850

(22) PCT Filed: Jan. 20, 2016
(86) PCT No.: PCT/CA2016/000016

§ 371 Date: May 10, 2017

(30) Foreign Application Priority Data
Feb. 10, 2015 (CA) 2881450

(51) Int. Cl. B60D 1/04; B60D 1/18; B60D 1/58

(52) U.S. Cl. CPC B60D 1/04; B60D 1/58; B60D 1/187

(57) ABSTRACT

A pintle hitch apparatus has a pintle hook with a base portion adapted at a front end thereof for attachment to a towing vehicle, a bend portion extending rearward from the base, and a pin extending upward from a rear end of the bend portion. A recess is defined in a top surface of the bend portion, and a wear member is releasably attached in the recess such that a top surface of the wear member is above the top surface of the bend portion.

This disclosure relates to the field of hitches for connecting a towed vehicle to a towing vehicle and in particular reducing wear and related expenses in such hitches.

### BACKGROUND

Pintle hook type hitch apparatuses typically comprise a hook assembly with a vertically oriented pin mounted to the towing vehicle, such as a truck. The pintle hook assembly has a bend portion extending rearward from a base portion that is attached to the towing vehicle and a pin extending upward from the rear of the bend portion. The hitch tongue of the towed vehicle has a ring on the forward end that is dropped down on the pin which extends up through the hole in the ring and the ring rests on top of the bend portion at the bottom of the pintle hook. A retainer is connected to the top of the pin over the gap between the pin and the base portion to prevent the ring from moving upward off the pin.

Such pintle hook hitch apparatuses are disclosed for example in U.S. Pat. No. 6,139,043 to Gries, et al. and 5,332,250 to Thorwall, et al.

The ring rests on the top surface of the bend portion of the pintle hook forward of the pin, and considerable movement is constantly taking place between the ring and the surface of the pintle hook as the vehicles travel, such that, especially where considerable weight is carried on the pintle hook, significant wear takes place on the pintle hook, requiring frequent monitoring and replacement.

Connecting mechanisms for trailers and like towed vehicles take a variety of forms. In addition to the above described pintle hook type hitches, clevis and tongue mechanisms and ball and socket mechanisms are also common. For on road use regardless of the type of connecting mechanism, many jurisdictions require that the hitch apparatus include a safety chain or like tether connected between the vehicles as well to keep the vehicles connected if the hitch connection mechanism fails.

Trailer safety chains are described in U.S. Pat. Nos. 6,179,317 to Hurst, et al. and 6,279,939 Austin. Typically there are right and left safety chains attached at rear ends thereof to the trailer on corresponding right and left sides of the trailer hitch member, and the front end of each chain comprises a hook or the like adapted to attach to the towing vehicle. The two separate chains provide redundancy in case one chain fails.

A problem with safety chains is that the location of the attachment points for the chains on the towing vehicle vary with the different towing vehicles used. The distance from the point where the trailer hitch member engages the hitch member of the towing vehicle can vary considerably from one towing vehicle to another. Thus the chains in some cases can be too short to reach the attachment location on the towing vehicle. To avoid that scenario where the safety chains are too short and the trailer connection cannot be made at all, it is common to make the chains quite long, such that in many cases once attached the chains droop and drag on the ground. This contact with the ground causes the links to wear and weaken the chain such replacement is required.

U.S. Pat. No. 5,918,896 to Jenkins, Jr. addresses the problem by providing a plate for attachment to the towing vehicle with apertures that engage the links of the chain. The engaged links can be chosen to adjust the effective length of chain between the towing vehicle and the trailer so that the chains do not drag on the ground.

U.S. Pat. No. 7,963,543 to Green discloses safety chain adjusting boxes with slots that engage each chain at a selected link to adjust the effective length of the chain.

### SUMMARY OF THE INVENTION

The present disclosure provides a pintle hitch apparatus that overcomes problems in the prior art.

Pintle hook hitch apparatuses are used in a wide variety of vehicles, from light trailers to large highway trailers weighing many tons. In the larger vehicles, the pintle hook is large and costly, and is subject to considerable wear from the forces exerted by the ring and the constant relative movement between the ring and the hook. The material of the hook is worn away and it is necessary to monitor the wear on the hook in order to ensure sufficient material is present to support the ring during travel. When the material has worn away to an unsafe degree the pintle hook must be replaced with a new one.

The portion of the pintle hook that is subjected to wear however is really quite small, being the top surface of the bend portion which supports the downward force of the weight on the ring, and the lower portion of the front surface of the pin, which bears against the ring to provide the forward force to tow the vehicle.

In a first embodiment the present disclosure thus provides a pintle hitch apparatus comprising a pintle hook comprising a base portion adapted at a front end thereof for attachment to a towing vehicle, a bend portion extending rearward from the base, and a pin extending upward from a rear end of the bend portion. A recess is defined in a top surface of the bend portion, and a wear member is releasably attached in the recess such that a top surface of the wear member is above a top surface of the bend portion.

The present disclosure further provides a safety chain apparatus for towed vehicles that overcomes problems in the prior art.

In a second embodiment the present disclosure provides a safety chain apparatus for a hitch assembly, the hitch assembly comprising a hitch member configured to connect a towing vehicle to a towed vehicle. The apparatus comprises a chain comprising a length of chain links, the chain attached at a rear end thereof to the towed vehicle and adapted at a front end thereof for releasable attachment to the towing vehicle. An engagement device is attached to the hitch member and configured to engage a selected link of the chain and secure the selected link in a support location where the chain is above a road surface. The engagement device is configured to release the selected link from the support location when a force exerted on the engagement device by the chain exceeds a release force.

The safety chain apparatus of the present disclosure secures one selected link of the chain in a supported location where slack portions between the engagement device and the vehicles are above the road surface. If the link is improperly selected such that one of the slack portions tightens while maneuvering the vehicles and exerts any significant force on the engagement device, the engagement device will allow the selected link to move away from the support location in response to the force, preventing damage to the hitch and vehicles.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic perspective view of an embodiment of the pintle hitch apparatus of the present disclosure with the wear member removed from the recess;

FIG. 2 is a schematic top view of the embodiment of FIG. 1 with the wear member installed in the recess;

FIG. 3 is a schematic side view of the embodiment of FIG. 1 with the wear member removed from the recess;

FIG. 4 is a schematic side view of the embodiment of FIG. 1 with the wear member installed in the recess;

FIG. 5 is a schematic side view of the embodiment of FIG. 1 with the wear member installed in the recess and a hitch ring supported on the pintle hook;

FIG. 6 is a schematic side view of an embodiment of a safety chain apparatus of the present disclosure;

FIG. 7 is a schematic top view of the embodiment of FIG. 6;

FIG. 8 is a schematic rear view of the right and left engagement devices engaged in selected links of the right and left chains;

FIG. 9 is a schematic side view of one of the engagement devices engaged in a selected links of one of the chains;

FIG. 10 is a schematic side view of the engagement device of the embodiment of FIG. 1 in original form shaped to engage and hold the selected link in the support location;

FIG. 11 is a schematic side view of the engagement device of the embodiment of FIG. 1 bent out of the original form, releasing the selected chain link from the support location;

FIG. 12 is schematic rear view of an alternate engagement device where the faster breaks when the release force is exceeded.

### DETAILED DESCRIPTION OF THE ILLUSTRATED EMBODIMENTS

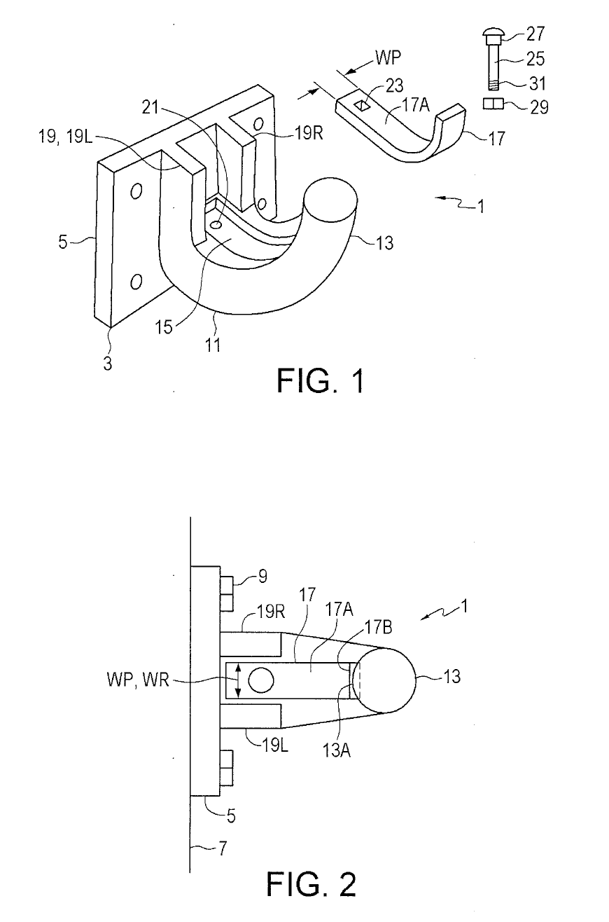

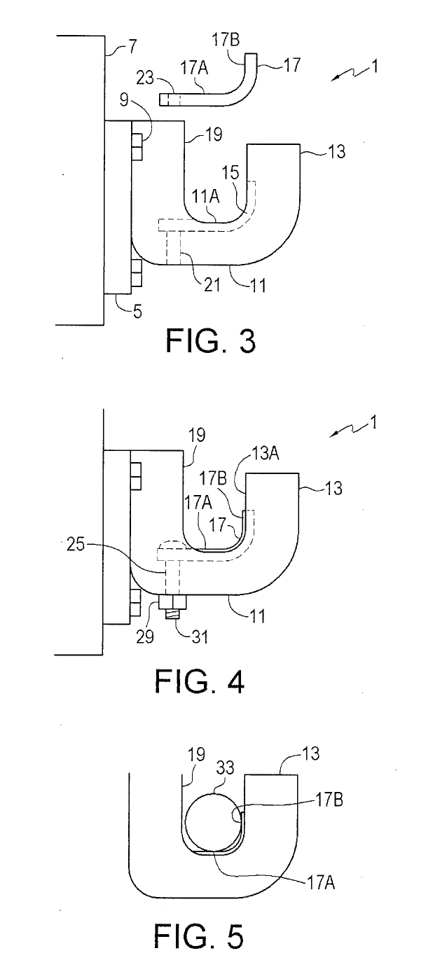

FIGS. 1-5 schematically illustrate an embodiment of a pintle hitch apparatus 1 of the present disclosure. The apparatus 1 comprises a pintle hook 3 such as is known in the prior art comprising a base portion 5 adapted at a front end thereof for attachment to a towing vehicle 7 by bolts 9 or like fasteners. A bend portion 11 extends rearward from the base portion 5, and a pin 13 extends upward from a rear end of the bend portion 11. A mechanism is also provided to prevent the ring of towed vehicle hitch from moving up and off the pin 13. Several such mechanisms are known in the prior art and can be used with the present pintle hitch apparatus 1, and are not further illustrated.

In the apparatus 1 of the present disclosure a recess 15 is defined in a top surface of the bend portion 11. The recess 15 extends upward along a lower portion of a front side of the pin 13. A wear member 17 is releasably attached in the recess 15 such that a top surface 17A of the wear member 17 is above a top surface 11A of the bend portion 11 that a front surface 17B of the wear member 17 is forward of a front surface 13A of the pin 13.

The base portion 5 comprises right and left base plates 19R, 19L extending upward from a front end of the bend portion 11 and the recess 15 extends forward between the base plates 19, and the wear member 17 extends forward in the recess 15 between the base plates 19. The base portion 5 defines a base fastener aperture 21 between the right and left base plates 19R, 19L, and the wear member defines a corresponding wear fastener aperture 23 that is aligned with the base fastener aperture 21 when the wear member 17 is in the recess 15, and comprising a fastener extending through the base fastener aperture and wear fastener aperture to releasably attach the wear member in the recess

The base portion 11 and the wear member 17 define corresponding fastener apertures 21, between the base plates 19, and a fastener 23 extends through the fastener apertures 21 to releasably attach the wear member 17 in the recess 15. In the illustrated apparatus 1 the wear member 17 is provided by a steel plate with a width WP substantially equal to a width WR of the recess 15 so that there is minimal relative movement between the wear member 17 and the base portion 5 of the apparatus 1.

Conveniently the wear fastener aperture 23 in the wear member is square, and the fastener is provided by a carriage bolt 25 with a square shank section 27 engaged in the wear fastener aperture 23. A nut 29 is engaged on the end 31 opposite the square shank section 27 and bears against the base portion 5. The use of the carriage bolt 25 in the square wear fastener aperture 23 allows the nut 29 to be tightened or loosened without the need to hold the carriage bolt 25, facilitating removal and replacement of the wear member 17.

FIG. 5 schematically illustrates the ring 33 of the hitch of a towed vehicle supported on the pintle hitch apparatus 1. The weight of the hitch is supported by the bottom of the ring 33 resting on the top surface 17A of the wear member 17. The draft forces required to exert a towing force on the ring 33 are exerted by the rear face of the ring 33 bearing against the front surface 17 B of the wear member 17. During travel the ring 33 and wear member 17 move with respect to each other causing wear on the ring 33 and the wear member 17. During stops, the ring 33 will bear against the rear of the base plates 19 however significant wear does not take place because the forces exerted by stopping are only occasional.

Wear on the wear member 17 is easily determined by monitoring whether the top and front surfaces 17A, 17B of the wear member are still above and forward of respectively the top surface 11A of the bend portion 11 and the front surface 13A of the pin 13. When the wear member 17 is worn to the extent that the ring begins to bear against the top surface 11A of the bend portion 11 or the front surface 13A of the pin 13 the nut 29 is removed, the carriage bolt 25 pulled out and a new wear member 17 installed.

Typically the steel plate wear member 17 will have a hardened top surface 17A and front surface 17B such that the Rockwell Scale hardness of the top and front surfaces 17A, 17B of the wear member 17 is greater than a Rockwell Scale hardness of the bend portion 11 and greater than a Rockwell Scale hardness of the pin 13.

The pintle hitch apparatus I of the present disclosure thus provides a small, inexpensive, and easily replaceable wear member 17 which can be easily monitored and replaced when necessary, extending the life of the much more expensive pintle hook 3 indefinitely.

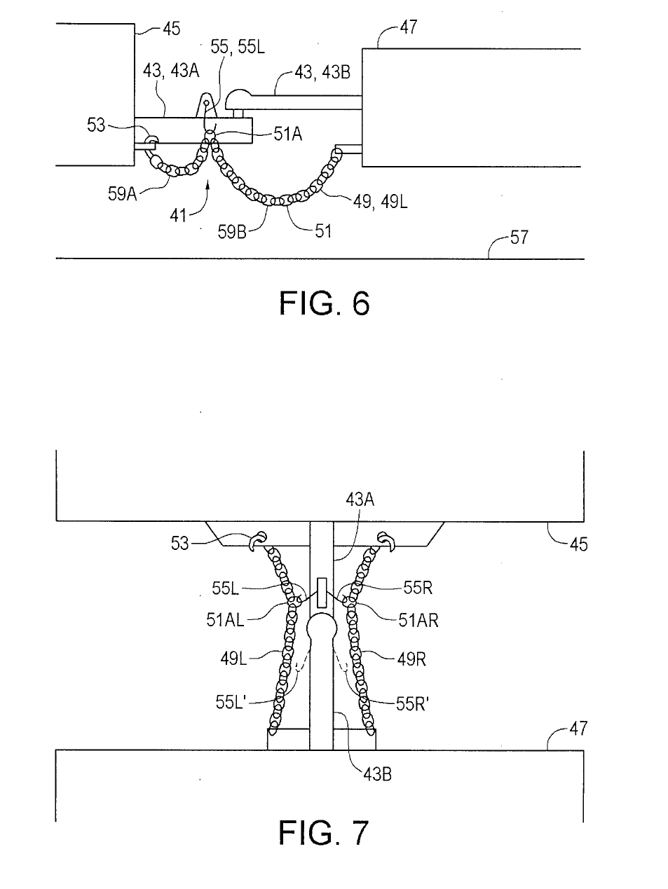

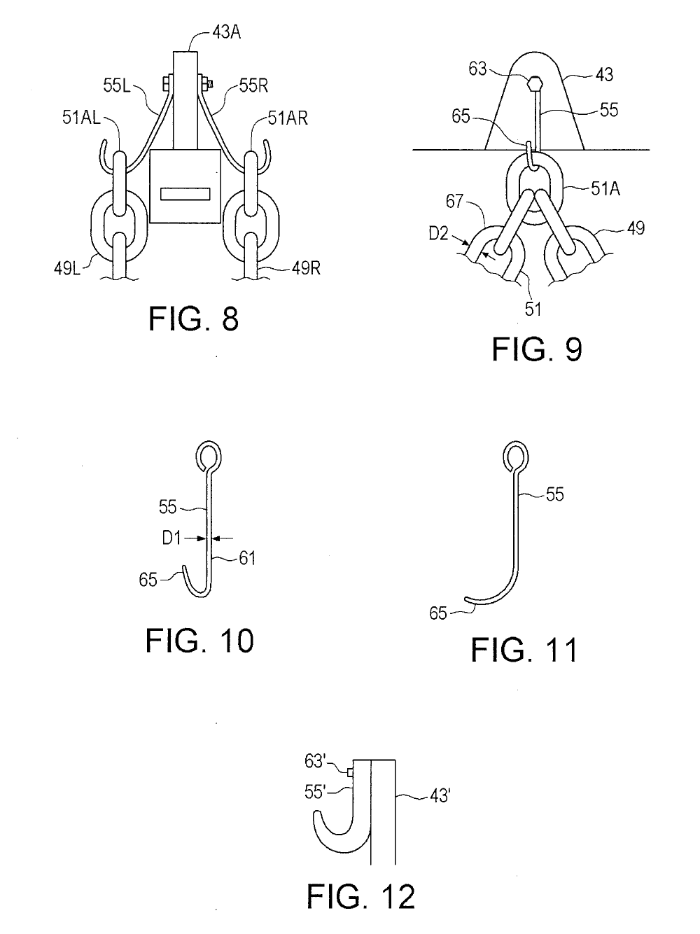

FIGS. 6-9 schematically illustrate an embodiment of a safety chain apparatus 41 of the present disclosure for a hitch assembly comprising a hitch member 43 configured to connect a towing vehicle to a towed vehicle. The hitch member could be a hitch member 43A attached to a towing vehicle 45 or a hitch member 43B attached to a towed vehicle 47.

The apparatus 1 comprises a chain 49 comprising a length of chain links 51. Typically the apparatus 1 will comprise right and left chains 49R, 49L, each chain 49 attached at a rear end thereof to the towed vehicle 47 and adapted at a front end thereof for releasable attachment to the towing vehicle 45, commonly by a hook 53 that can be engaged in an aperture on the towing vehicle 45 or the hitch member 43A attached thereto.

Right and left engagement devices 55R, 55L are each configured to engage a selected link 51AR, 51AL of the corresponding right and left chains 49R, 45L and secure the selected links 51A in a support location as illustrated where the chains 49 are above a road surface 57. The engagement devices 55 are shown attached to the hitch member 43A attached to a towing vehicle 45, but could as well be attached, as shown in phantom lines as 55R′, 55L′ in FIG. 7, to the hitch member 43B attached to the towed vehicle 47. The engagement devices 55 are configured to release the selected links 51A from the support location when a force is exerted on the engagement device 55 by the chain 49 that exceeds a release force.

Thus if the selected link 51A is mistakenly selected such that during a turn the towing vehicle 45 and towed vehicle 47 become oriented such that the slack chain portion 59A between the towing vehicle 45 and the selected link 51A or the slack chain portion 59B between the towed vehicle 47 and the selected link 51A tightens such that the chain 49 pulls on the engagement device 55, the engagement device will bend, break, or otherwise release the engaged link 51A from the support location so that damage to the vehicles or a broken chain or like harm does not result.

In the illustrated apparatus 41 the engagement device 55 is configured to bend to release the engaged link 51 from the support location. As schematically illustrated in FIGS. 10 and 11 the engagement device 55 is provided by a hanger member formed from a wire hanger rod 61 and attached to the hitch member 43A with a bolt 63 and configured such that a hook end 65 of the hanger member passes through the selected link 51A and supports the selected link in the support location. The wire hanger rod 61 has a diameter D1 that is less than about one third of a diameter D2 of a chain rod 67 forming the chain links 51.

The diameter D1 dictates the release force necessary to release the selected link 51A. D1 only needs to be sufficient to support the loose chain 49 above the road surface, and so can be quite small, with a resultant small release force. It is generally desirable that the diameter DI be selected such that if either slack portion 59A or 59B tightens and exerts any significant chain force on the engagement device 55, the wire rod 61 should bend to a general shape shown in FIG. 11 where the hook end 65 is straightened and the selected link has fallen off the engagement device 55. If the chain force is exerted only for a short distance the wire rod 61 may bend only slightly but the selected link 51A may remain on the hook end 61.

FIG. 12 schematically illustrates an alternate engagement device 55′ where the engagement device 55′ is attached to the hitch member 43′ by a fastener 63′ and wherein the fastener 63′ is small and light and configured to break to release the selected link 51 from the support location.

The safety chain apparatus 41 of the present disclosure secures one selected link 55A of the chain 49 in a supported location. The link 55A is selected such that slack portions 59A, 59B between the engagement device 55 and the vehicles 45, 47 are above the road surface 57. If the link 55A is improperly selected such that one of the slack portions 59A, 59B tightens while maneuvering the vehicles and exerts a force on the engagement device 55 that exceeds a small release force, the engagement device will allow the selected link 55A to move away from the support location, preventing damage to the apparatus 41 and vehicles 45, 47.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A pintle hitch apparatus comprising:
a pintle hook comprising a base portion adapted at a front end thereof for attachment to a towing vehicle, a bend portion extending rearward from the base, and a pin extending upward from a rear end of the bend portion;
a recess defined in a top surface of the bend portion;
a wear member releasably attached in the recess such that a top surface of the wear member is above a top surface of the bend portion.

2. The apparatus of claim 1 wherein the recess extends upward along a lower portion of a front side of the pin, and wherein an upright portion of the wear member extends upward in the recess along the front side of the lower portion of the pin such that a front surface of the wear member is forward of a front surface of the pin.

3. The apparatus of claim 1 wherein the base portion comprises right and left base plates extending upward from a front end of the bend portion and wherein the recess extends forward between the right and left base plates, and the wear member extends forward in the recess between the right and left base plates.

4. The apparatus of claim 3 wherein the base portion defines a base fastener aperture between the right and left base plates, and wherein the wear member defines a corresponding wear fastener aperture that is aligned with the base fastener aperture when the wear member is in the recess, and comprising a fastener extending through the base fastener aperture and wear fastener aperture to releasably attach the wear member in the recess.

5. The apparatus of claim 4 wherein the fastener aperture in the wear member is substantially square, and wherein the fastener is provided by a carriage bolt with a square shank section engaged in the fastener aperture in the wear member, and a nut engaged on an end thereof opposite the square shank section and bearing against the base portion.

6. The apparatus of claim 1 wherein the wear member is provided by a steel plate with a width substantially equal to a width of the recess.

7. The apparatus of claim 6 wherein the wear member comprises hardened top and front surfaces.

8. The apparatus of claim 1 wherein the Rockwell Scale hardness of the top and front surfaces of the wear member is greater than a Rockwell Scale hardness of the bend portion and greater than a Rockwell Scale hardness of the pin.

9. A safety chain apparatus for a hitch assembly, the hitch assembly comprising a hitch member configured to connect a towing vehicle to a towed vehicle, the apparatus comprising:
a chain comprising a length of chain links, the chain attached at a rear end thereof to the towed vehicle and adapted at a front end thereof for releasable attachment to the towing vehicle;
an engagement device attached to the hitch member and configured to engage a selected link of the chain and secure the selected link in a support location where the chain is above a road surface;
wherein the engagement device is configured to release the selected link from the support location when a force exerted on the engagement device by the chain exceeds a release force.

10. The apparatus of claim 9 wherein the engagement device is configured to bend to release the selected link.

11. The apparatus of claim 10 wherein the engagement device is provided by a hanger member configured such that a hook end of the hanger member passes through the selected link.

12. The apparatus of claim 11 wherein the hanger member is formed from a wire hanger rod, and wherein a diameter of the wire hanger rod is less than about one third of a diameter of a chain rod forming the chain links.

13. The apparatus of claim 9 wherein the engagement device is attached to the hitch member by a fastener and wherein the fastener is configured to break to release the selected link.

14. The apparatus of claim 9 comprising right and left chains, each chain attached at a rear end thereof to the towed vehicle and adapted at a front end thereof for releasable attachment to the towing vehicle, and right and left engagement devices, each configured to engage a selected link of the corresponding right and left chains to support the chains above the road surface.
